(19) United States
(12) Patent Application Publication
(10) Pub. No.: US 2003/0126239 A1
(43) Pub. Date: Jul. 3, 2003

(54) Mobile communication terminal, network access system and method thereof using the same

(76) Inventor: Hye-sook Hwang, Seoul (KR)

Correspondence Address: BIRCH STEWART KOLASCH & BIRCH, PO BOX 747, FALLS CHURCH, VA, 22040-0747, US

(21) Appl. No.: 10/330,335

(22) Filed: Dec. 30, 2002

(30) Foreign Application Priority Data
Dec. 31, 2001 (JP) 88824/2001

(51) Int. Cl. G06F 15/177

(52) U.S. Cl. 709/220

(57) ABSTRACT

In a mobile communication terminal, a network access system and a method thereof using the same capable of controlling an UPnP device and connecting it to an external network, by including an UPnP control point application and a network conversion function for converting an IP address authenticated in a home network into an IP address of an external network in an OS of a mobile communication terminal, a user can easily control UPnP devices even in moving and connect them to an external network through the Internet without using an additional Internet access equipment. In addition, by using a Korean, English, number and special character input function and a voice recognition function of a mobile communication terminal, the user can control the UPnP devices efficiently.

### BACKGROUND OF THE INVENTION

1. Field of the Invention

The present invention relates to a home network, and in particular to a mobile communication terminal, a network access system and a method thereof using the same capable of controlling a UPnP (universal plug and play) device and connecting it to an external network.

2. Description of the Prior Art

Recently, according to the developments of information techniques, various IT products such as a PC (personal computer), a mobile phone, a digital television receiver, a PDA (personal digital assistant), a play station, etc. are connected to a network as home network devices, and accordingly a home network gets into the spotlight.

The home network means connecting home network devices in a home with one topology, owning digital data jointly and using a broadband communication. In more detail, the home network in a narrow sense means wire and radio network equipment itself, the home network in a broad sense means a middle wear or a service, etc. for mutual integration/control/operation among home network devices including the wire and radio network equipment.

In particular, an UPnP (universal plug and play) has came to the fore at the present time as a middle wear for mutual integration/control/operation among home network devices. The UPnP is a common protocol for making various home network devices having different standard specifications interface with each other by expanding the existing plug and play function.

FIG. 1 is block diagram illustrating a general UPnP home network.

As depicted in FIG. 1, in the UPnP home network, generally, UPnP devices (an UPnP refrigerator, an UPnP washing machine, etc.) and an UPnP control device (herein, a digital television receiver) are connected with one topology, those home network devices are connected to an ISP (Internet service provider) through a home gateway and receives various Internet services. For example, in order to control the UPnP refrigerator and washing machine, etc. as UPnP devices, the digital television receiver as an UPnP control device having an “UPnP control point application” as a control application program is required, and an additional home gateway equipment is required in order to access those devices to the ISP.

As described above, in the present UPnP home network, in order to connect the UPnP devices in a home to the external network, a home gateway such as a cable modem is required. In addition, an additional UPnP control device is required in order to connect and control/operate the UPnP devices as home appliances in the home through the UPnP home network.

### SUMMARY OF THE INVENTION

In order to solve the above-mentioned problem, it is an object of the present invention to provide a mobile communication terminal, a network access system and a method thereof using the same capable of controlling UPnP devices and connecting them to an external network by adding a home gateway function and an UPnP control point application function to a mobile communication terminal.

In order to achieve the above-mentioned object, a mobile communication terminal in accordance with the present invention includes an UPnP control point for controlling an UPnP device; and a gateway for performing access to an external network.

In order to achieve the above-mentioned object, a network access system in accordance with the present invention includes an UPnP device for requesting and receiving an Internet service by accessing to a home network with a local IP thereof; an external network server for providing the Internet service requested by the UPnP device by using a global IP thereof; and a mobile communication terminal for mutual-converting a local IP of the UPnP device and the global IP of the pertinent external network server in order to perform the Internet connection.

In order to achieve the above-mentioned object, a network access method using a mobile communication terminal in accordance with the present invention includes transmitting a request message for requesting an Internet service to a mobile communication terminal by an UPnP device accessed to a home network by using a local IP thereof; parsing the transmitted request message and converting the local IP of the UPnP device into a global IP of an external network server by the mobile communication terminal; processing the requested Internet service by the pertinent external network server corresponding to the converted global IP and transmitting it to the mobile communication terminal; parsing a reply message and converting the global IP of the external network server into the local IP of the UPnP device by the mobile communication terminal; and transmitting the reply message to the pertinent UPnP device corresponding to the converted local IP.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is block diagram illustrating a general UPnP home network;

FIG. 2 is an exemplary view illustrating a network access system including a home network by using a mobile communication terminal in accordance with the present invention;

FIG. 3 is an exemplary view illustrating a mobile communication terminal including an UPnP control point function and a gateway function in accordance with the present invention;

FIG. 4 is an exemplary view illustrating a communication protocol of the mobile communication terminal in accordance with the present invention;

FIG. 5 is a block diagram illustrating an internal construction of the mobile communication terminal in accordance with the present invention;

FIG. 6 is an exemplary view illustrating an access method of UPnP devices with an external network by using the mobile communication terminal in accordance with the present invention;

FIG. 7 is an exemplary view illustrating a network conversion method of the mobile communication terminal in accordance with the present invention;

FIG. 8 is an exemplary view illustrating an access method of UPnP devices with an external network in accordance with the present invention required when the plural UPnP devices request the Internet access simultaneously; and

FIG. 9 is an exemplary view illustrating a network conversion method of a mobile communication terminal in accordance with the present invention required when the plural UPnP devices simultaneously request the Internet access.

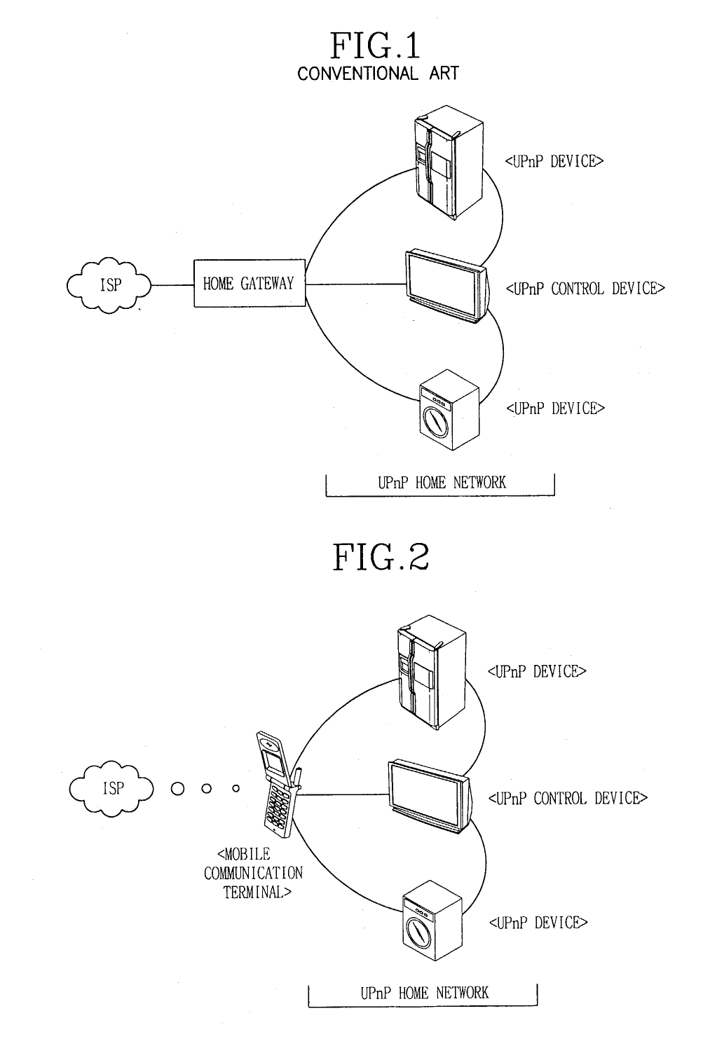

### DETAILED DESCRIPTION OF THE PREFERRED EMBODIMENT

FIG. 2 is an exemplary view illustrating a network access system including a home network by using a mobile communication terminal in accordance with the present invention.

As depicted in FIG. 2, the network access system using the mobile communication terminal includes an UPnP device for requesting an Internet access to a pertinent external network server; a mobile communication terminal for mutual-converting a local IP of the UPnP device into a global IP of the pertinent external network server and performing a gateway function according to the Internet access request; and an ISP (Internet service provider) for Internet-accessing to the UPnP device through the mobile communication terminal.

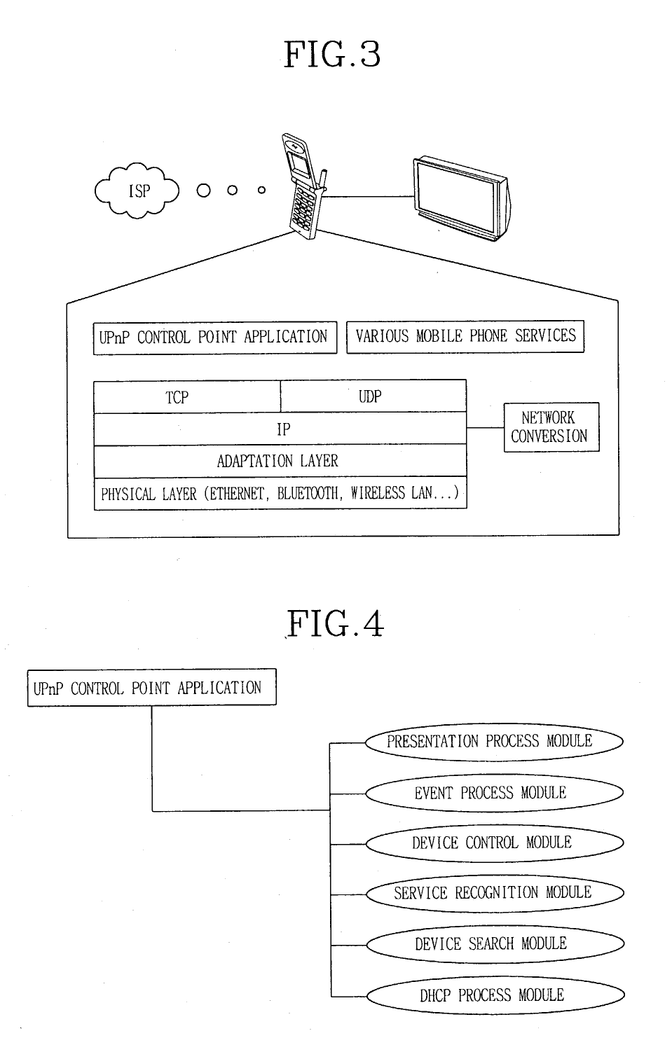

FIG. 3 is an exemplary view illustrating a mobile communication terminal having an UPnP control point and a gateway in accordance with the present invention.

As depicted in FIG. 3, the mobile communication terminal includes an “UPnP control point application” for controlling the UPnP device above a TCP/IP layer included in a real time OS (operating system). Accordingly, the mobile communication terminal performs the gateway function for controlling the UPnP device and accessing to the Internet. Herein, in order to perform the UPnP function and the gateway function simultaneously, the mobile communication terminal divides a bandwidth into an internal network and an external network in a physical layer.

FIG. 4 is an exemplary view illustrating a communication protocol of the mobile communication terminal in accordance with the present invention.

As depicted in FIG. 4, the “UPnP control point application” largely consists of a DHCP process module, a device search module, a service recognition module, a device control module, an event process module and a presentation process module, etc.

The DHCP process module is for managing a local IP (Internet protocol) allocated from a DHCP server (dynamic host configuration protocol). In more detail, each UPnP device constructing the home network has a local IP thereof on the basis of a TCP/IP.

When the UPnP devices are connected through the UPnP home network, the device search module is for searching and recognizing the UPnP devices connected to an UPnP control device performing as an UPnP control point.

The service recognition module is for recognizing various service functions, etc. provided by the UPnP devices through a description file recognized by the device search module. Herein, the description file is largely divided into a device description file for informing detailed information each device and a service description file for informing a service function, etc. of each device.

The device control module is for controlling the UPnP devices connected thereto.

The event process module is for informing a present state of each UPnP device.

Lastly, the presentation process module is for presenting various service functions, etc. provided by the UPnP devices to a user, and it is provided as an option in an UPnP basic spec.

In more detail, the mobile communication terminal is operated as the UPnP control point by including the “UPnP control point application” above the basic TCP/IP later.

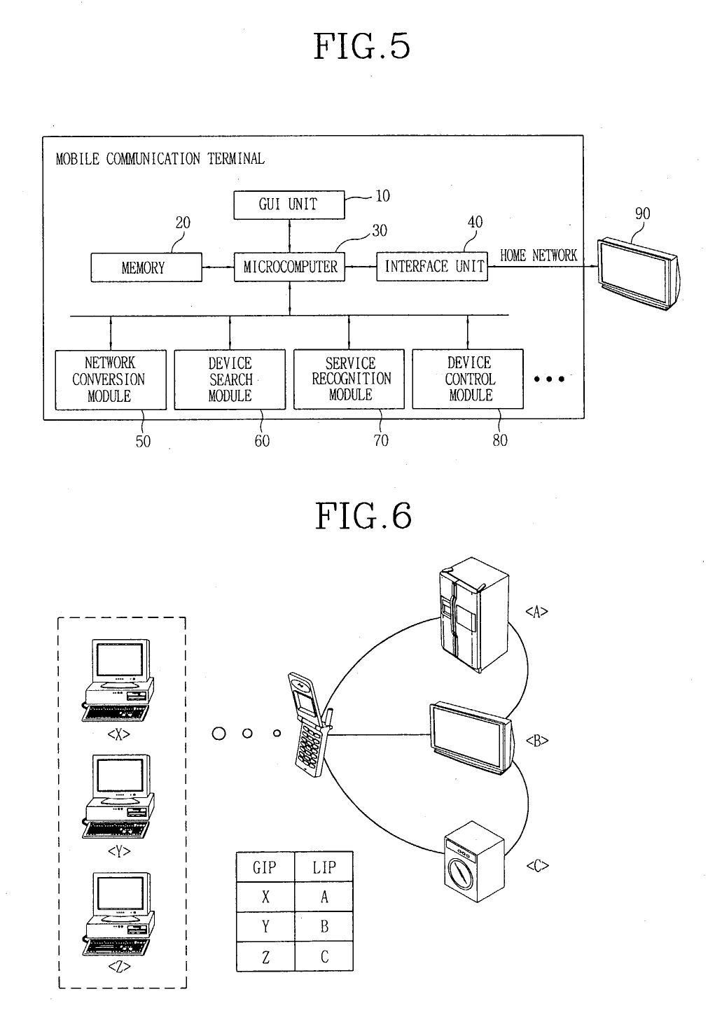

FIG. 5 is a block diagram illustrating an internal construction of the mobile communication terminal in accordance with the present invention.

As depicted in FIG. 5, the mobile communication terminal in accordance with the present invention includes an interface unit 40 for receiving a device description file and a service description file from an UPnP device 90 having a local IP; a device search module 60 for searching the pertinent UPnP device 90 by parsing the received device description file; a service recognition module 70 for recognizing a service function of the pertinent UPnP device 90 by parsing the received service description file; a device control module 80 for controlling the UPnP device 90 by using the recognized service function; a memory 20 for storing the searched device information and information about the service function; a GUI (graphical user interface) unit 10 for presenting the searched device information and information about the service function; a network conversion module 50 for mutual-converting the local IP of the UPnP device 90 into a global IP as an IP address necessary to access with an external network; and a microcomputer 30 for controlling each unit 10, 20, 40, 50, 60, 70, 80.

The operation of the mobile communication terminal in accordance with the present invention will be described.

First, the mobile communication terminal as the UPnP control device and the digital television receiver (hereinafter, it is referred to “DTV”) as the UPnP device 90 are allocated a local IP address from a DHCP (dynamic host configuration protocol) server, the DTV multicasts an advertisement message thereof to the interface unit 40 of the mobile communication terminal by using the address.

Then, the device search module 60 parses the multicast advertisement message under the control of the microcomputer 60 and recognizes a network position of the UPnP device, namely, the DTV and pertinent product information, etc.

The recognition is performed through the local IP of the DTV and an UUID (unique universe identifier) as a device recognition identifier, the UUID of the DTV is an inherent identifier informing the DTV is a video medium, namely, a digital television receiver, it is set and stored in fabrication.

In the meantime, through the advertisement message, the mobile communication terminal as the UPnP control device recognizes the UPnP device 90, namely, the DTV connected thereto, the service recognition module 70 requests a description file of the DTV under the control of the microcomputer 30.

The description file includes device description information related to a device and an UPnP service description information. The device description information includes a device type, a device model name/URL/Number, a device serial number, a device manufacturer name and a URL (UNIFORM RESOURCE LOCATOR) of the manufacturer, etc. In addition, the service description information includes a service type (for example: picture type), service kinds of the device, state variable (for example: channel adjustment or volume adjustment) and an action list (for example: channel up/down or volume up/down).

When the service recognition module requests the description information, the DTV transmits a SCPD (service control protocol definition) URL indicating a position at which the description file is stored to the interface unit 40 of the mobile communication terminal.

When the interface unit 40 of the mobile communication terminal receives the SCPD URL, the service recognition module 70 calls out the description file indicated by the transmitted SCPD URL under the control of the microcomputer 30 and receives the description file of the DTV.

Afterward, by parsing the description file, when it is recognized there are various control information such as services of the DTV such as “channel up/down” and “volume up/down” or event information informing a present state, the device control module 80 requests the DTV to transmit those information under the control of the microcomputer 30. In more detail, when <control URL> indicating a URL at which the above-mentioned information is stored and <eventSub URL> indicating a present state are transmitted to the interface unit 40 of the mobile communication terminal, the device control module 80 calls out the pertinent information in which the transmitted URL indicates under the control of the microcomputer 30, downloads it and controls the DTV as the UPnP device.

In the meantime, in the mobile communication terminal controllable the UPnP device 90 through the above-described operation, in order to connect the UPnP device to the external network server, the network conversion module 50 for converting the UPnP home network address into an external network address is required. In more detail, because the local IP allocated to the UPnP device 90 is authenticated only in the UPnP home network, it has to be converted into a global IP address allocated from the pertinent external network in order to be connected with the external network.

For example, when the UPnP device 90 requests the Internet service to a pertinent web server of the external network, when a request message having the local IP as a source address and a global IP (the pertinent web server address) as a destination address, the network conversion module 50 of the mobile communication terminal transmits it after converting the source address of the message into a global IP allocated to the mobile communication terminal.

And, when the pertinent web server transmits a web file about the pertinent Internet service as a reply about the request, in more detail, the web server transmits a reply message having the global IP as the source address and the destination address, the network conversion module 50 of the mobile communication terminal converts it the destination address of the reply message into the local IP of the pertinent UPnP device and transmits it, and accordingly the mobile communication terminal can perform the home gateway function.

Next, a network access method using the mobile communication terminal will be described with reference to accompanying FIGS. 6˜9.

FIG. 6 is an exemplary view illustrating an access method of UPnP devices with an external network by using the mobile communication terminal in accordance with the present invention.

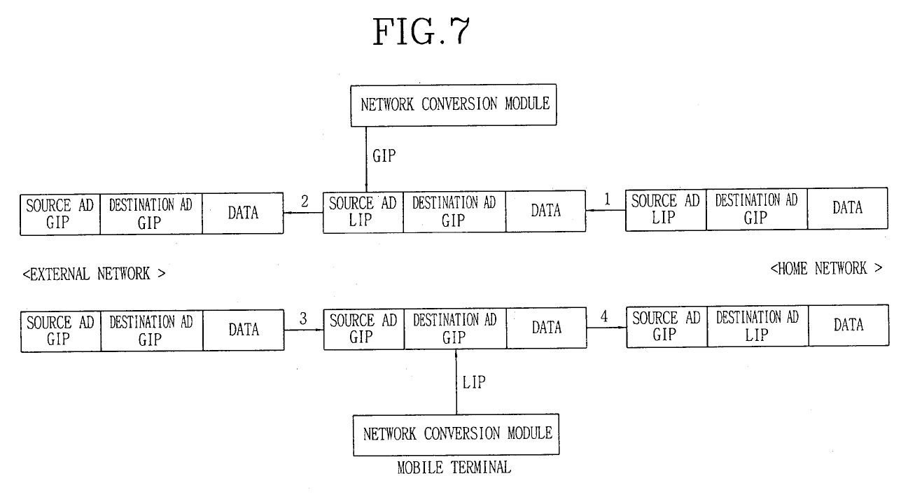

FIG. 7 is an exemplary view illustrating a network conversion method of the mobile communication terminal in accordance with the present invention.

As depicted in FIGS. 6 and 7, the external network access method using the mobile communication terminal in accordance with the present invention includes requesting an Internet access with a pertinent external network server by an UPnP device; mutual-converting a local IP of the pertinent UPnP device and a global IP of the pertinent external network by the mobile communication terminal as a home gateway; and Internet-connecting the external network server of the converted global IP with the UPnP device through the mobile communication terminal.

It will be described in more detail.

First, when a local IP of an UPnP refrigerator is “A”, a local IP of a DTV is “B”, a local IP of an UPnP washing machine is “C”, when a user requests to transmit a pertinent web file by accessing to an external network server “Y” through the DTV, the DTV transmits the request message to the mobile communication terminal. Herein, in the request message, the local IP (“B”) of the DTV is encoded as a source address, the global IP (“Y”) of the external network server is encoded as a destination address.

Afterward, when the request message is transmitted to the mobile communication terminal, the mobile communication terminal converts the local IP (“B”) as the source address of the request message into the global IP (“Y”) and records the conversion information in a conversion table having a lockup table format.

Afterward, when the request message in which the source address is converted into the local IP (“B”) is transmitted to the external network server (“Y”), the external network server (“Y”) process the user request Internet service by parsing the transmitted request message, encodes a web file generated as a result in a reply message and transmits it to the mobile communication terminal. Herein, the global IP (“Y”) is encoded as an source address and a destination address of the reply message.

In the meantime, when the mobile communication terminal receives the reply message, it parses it and converts the global IP (“Y”) as the destination address of the reply message into the local IP (“B”) of the pertinent UPnP device, namely, the refrigerator by using the conversion information recorded in the conversion table.

Then, the DTV receives the converted replay message, parses it and presents the pertinent web file encoded in the reply message to the user.

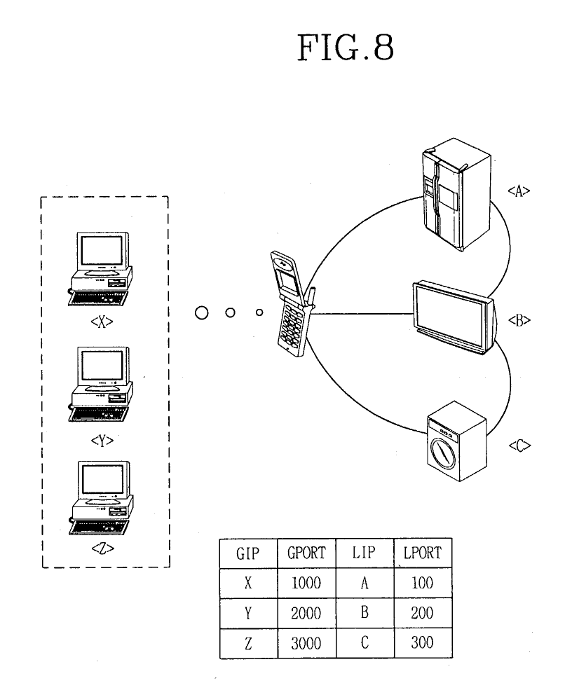

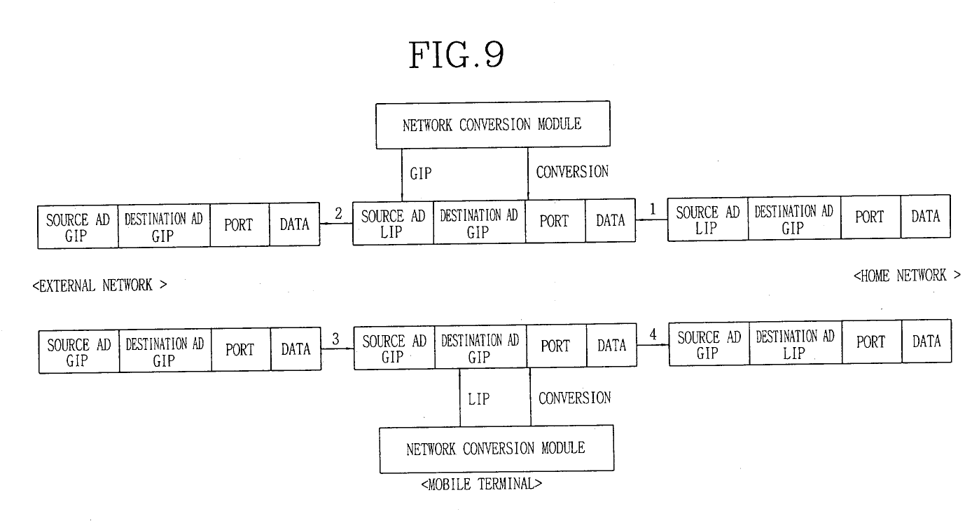

In the meantime, FIGS. 8 and 9 illustrate an access method of the UPnP devices with the external network required when the plural UPnP devices simultaneously request the Internet access.

FIG. 8 is an exemplary view illustrating an access method of UPnP devices to an external network required when the plural UPnP devices simultaneously request the Internet access.

FIG. 9 is an exemplary view illustrating a network conversion method of a mobile communication terminal required when the plural UPnP devices simultaneously request the Internet access.

First, when the user simultaneously accesss to a web server “Y” of the DTV and a web server “Z” of the UPnP washing machine and requests the mobile communication terminal to transmit a pertinent web file, a port is additionally required per each UPnP device. Herein, when a local IP address of an UPnP refrigerator is allocated as “A”, a local IP address of the DTV is allocated as “B”, and a local IP address of the UPnP mashing machine is allocated as “C”. In addition, when a port of the UPnP refrigerator as an identifier is allocated as “100”, a port of the DTV is allocated as “200”, and a port of the UPnP washing machine is allocated as “300”.

According to that, in the request message, the local IP “B” of the DTV is encoded as a source address, a L port (local port) is encoded as “200”, and a destination address is encoded as the global IP “Y” as the pertinent web server address of the external network. In addition, the local IP “C” of the UPnP washing machine is encoded as a source address, the L port is encoded as “300”, and a destination address is encoded as the global IP “Y” as the pertinent web server address of the external network.

When those request messages are transmitted to the mobile communication terminal at the same time, the mobile communication terminal converts the source address encoded in the request message of the DTV, namely, the local IP “B” into the global IP “Y”, converts the L port 200 into a G port (global port) “2000” and records the conversion information in the conversion table having the lookup table format. And, at the same time, the mobile communication terminal converts the source address encoded in the request message of the UPnP washing machine, namely, the local IP “Z” into the global IP “Z”, converts the L port 300 into a G port (global port) “3000”, records the conversion information and transmits the request messages to the pertinent web servers Y, Z respectively.

Then, the pertinent web server processes the request message and transmits a reply message to the mobile communication terminal. Herein, in the reply message of the web server Y, a global IP “Y” is encoded as a source address and a destination address, and G port “2000” is encoded. In addition, in the reply message of the web server “Z”, a global IP “Z” as encoded as a source address and a destination address, and G port “3000” is encoded.

Afterward, the mobile communication terminal receives the encoded reply message, parses it and performs a network conversion process.

In the network conversion process, the global IP “Y” as the destination address encoded in the reply message of the web server “Y” is converted into the local IP “B” of the pertinent UPnP device, namely, the DTV by using the conversion information recorded in the conversion table, and the G port “2000” is converted into the L port “200”. In addition, the global IP “Z” as the destination address encoded in the reply message of the web server “Z” is converted into the local IP “C” of the UPnP washing machine by using the conversion information recorded in the conversion table, and the G port “3000” is converted into the L port “300”.

Then, the converted reply message is respectively transmitted to the pertinent device, and accordingly each UPnP device can receive an Internet service provided from the external network.

As described above, because a mobile communication terminal performing an UPnP control device function performs a home gateway function providing a network address conversion function, each UPnP device can access to a pertinent web server of an external network through the mobile communication terminal.

As described above, in the mobile communication terminal, the network access system and the method thereof using the same in accordance with the present invention, by adding a home gateway function and an UPnP control device function to a mobile communication terminal, a user can easily control UPnP devices even in moving and connect them to an external network through the Internet without using an additional Internet access equipment. In addition, by using a Korean, English, number and special character input function and a voice recognition function of a mobile communication terminal, the user can control the UPnP devices efficiently.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A mobile communication terminal, comprising:
an UPnP control point for controlling an UPnP device; and
a gateway for performing access to an external network.

2. The mobile communication terminal of claim 1, wherein the UPnP control point includes an “UPnP control point application” above a TCP/IP layer of an OS (operating system) in order to control the UPnP device.

3. The mobile communication terminal of claim 2, wherein the UPnP control point application includes:
a DHCP (dynamic host configuration protocol) process module for managing an IP (Internet protocol) address allocated from a DHCP server;
a device search module for searching and recognizing an UPnP device connected to the mobile communication terminal;
a service recognition module for recognizing various service functions provided by the UPnP device through a description file of the UPnP device recognized by the device search module;
a device control module for controlling the UPnP device connected to the mobile communication terminal;
an event process module for informing a present state of the UPnP device; and
a presentation process module for presenting various service functions provided by the UPnP device to a user according to the present state of the UPnP device.

4. The mobile communication terminal of claim 3, wherein the description file includes a device description file for informing detailed information of the UPnP device and a service description file for informing a service function, etc. of the UPnP device.

5. The mobile communication terminal of claim 1, wherein the mobile communication terminal includes:
an interface unit for receiving a device description file and a service description file from an UPnP device having a local IP;
a device search module for searching the pertinent UPnP device by parsing the received device description file;
a service recognition module for recognizing a service function of the pertinent UPnP device by parsing the received service description file;
a device control module for controlling the UPnP device by using the recognized service function;
a memory for storing the searched device information and information about the service function;
a GUI unit for presenting the searched device information and information about the service function; and
a microcomputer for controlling each unit.

6. The mobile communication terminal of claim 5, wherein the mobile communication terminal further includes:
a network conversion module for mutual-converting the local IP of the UPnP device into a global IP in order to access with an external network.

7. The mobile communication terminal of claim 1, wherein the UPnP device includes a port for identifying itself among other UPnP devices.

8. A network access system, comprising:
an UPnP device for requesting and receiving an Internet service by accessing to a home network with a local IP thereof;
an external network server for providing the Internet service requested by the UPnP device by using a global IP thereof; and
a mobile communication terminal for mutual-converting a local IP of the UPnP device and the global IP of the pertinent external network server in order to perform the Internet connection.

9. The system of claim 8, wherein the mobile communication terminal controls the UPnP device by using a Korean, English, number and special character input function and a voice recognition function thereof.

10. The system of claim 8, wherein the mobile communication terminal outputs an order to the UPnP device by dividing a bandwidth in a physical layer of a communication protocol or receives a service provided from the external network server.

11. The system of claim 8, wherein the mobile communication terminal includes:
a network conversion module for mutual-converting a local IP and a global IP in order to access with an external network;
an interface unit for receiving a device description file and a service description file from an UPnP device having a local IP;
a device search module for searching the pertinent UPnP device by parsing the received device description file;
a service recognition module for recognizing a service function of the pertinent UPnP device by parsing the received service description file;
a device control module for controlling the UPnP device by using the recognized service function; and
a microcomputer for controlling each unit.

12. The system of claim 11, wherein the mobile communication terminal further includes:
a memory for storing the searched device information and information about the service function; and
a GUI unit for presenting the searched device information and information about the service function.

13. The system of claim 8, wherein the UPnP device includes a port for identifying itself among other UPnP devices.

14. A network access method using a mobile communication terminal, comprising:
transmitting a request message for requesting an Internet service to a mobile communication terminal by an UPnP device accessed to a home network by using a local IP thereof;
parsing the transmitted request message and converting the local IP of the UPnP device into a global IP of an external network server by the mobile communication terminal;
processing the requested Internet service by the pertinent external network server corresponding to the converted global IP and transmitting it to the mobile communication terminal;
parsing a reply message and converting the global IP of the external network server into the local IP of the UPnP device by the mobile communication terminal; and
transmitting the reply message to the pertinent UPnP device corresponding to the converted local IP.

15. The method of claim 14, wherein the step for transmitting the request message to the mobile communication terminal includes the sub-steps of:
encoding the local IP of the UPnP device as a source address; and
encoding the global IP of the external network as a destination address.

16. The method of claim 14, wherein the step for converting the local IP into the global IP includes the sub-steps of:
converting the local IP as the source address of the request message into the global IP by the mobile communication terminal; and
recording conversion information in a conversion table having a lookup table format.

17. The method of claim 14, wherein the step for transmitting the reply message to the mobile communication terminal includes the sub-steps of:
processing the user request Internet service by parsing the transmitted request message by the external network server; and
transmitting the reply message to the mobile communication terminal by encoding a web file as the processing result,
wherein, a source address and a destination address of the reply message are encoded as the global IP.

18. The method of claim 14, wherein the step for converting the global IP into the local IP includes the sub-steps of:
receiving the reply message by the mobile communication terminal;
parsing it; and
converting the global IP as the destination address of the reply message into the local IP of the pertinent UPnP device by using the conversion information recorded in the conversion table.

19. The method of claim 14, wherein the step for transmitting the reply message to the UPnP device includes the sub-steps of:
receiving the reply message converted local IP as the destination address by the UPnP device;
parsing it; and
presenting the pertinent encoded web file to a user.

20. The method of claim 14, wherein the UPnP device includes a port for identifying itself among other UPnP devices.
